(19) United States
(12) Patent Application Publication
(10) Pub. No.: US 2025/0186897 A1
(43) Pub. Date: Jun. 12, 2025

(54) HAND-WORN AND FINGER-OPERATED ANIMAL PUPPET TOY WITH INTEGRATED STIMULANTS

(71) Applicant: Andrew Robert Bruce, San Francisco, CA (US)

(72) Inventor: Andrew Robert Bruce, San Francisco, CA (US)

(21) Appl. No.: 19/054,967

(22) Filed: Feb. 17, 2025

Related U.S. Application Data
(60) Provisional application No. 63/556,384, filed on Feb. 21, 2024.

(51) Int. Cl. A63H 3/14; A01K 15/02; A63H 3/02; A63H 5/00

(52) U.S. Cl. CPC A63H 3/14; A63H 3/02; A01K 15/025; A63H 5/00

(57) ABSTRACT

A hand-manipulated puppet of the type simulating an animal (E.g. a cat) having a head, a body portion with four limbs/arms, and a sleeve is presented. The sleeve is attached to the animal's body portion. The puppet includes a wearable band and/or attire covering a portion of animal's body portion. The puppet include selectively includes pocket(s) on the limbs/arms, and/or the sleeve, and/or the wearable band for receiving stimulants. The pocket(s) are adapted for receiving pouches filled with stimulants. An operator's forearm or a portion of the forearm is laid into the sleeve whereas the palm portion, specifically the five fingers of the operator can get into the animal's body portion and used for selectively manipulate the animal's mouth, and four arms.

### CROSS-REFERENCE TO RELATED APPLICATIONS

The present application hereby claims priority to and incorporates by reference the entirety of the disclosures of the provisional application No. 63/556,384 entitled “HAND-WORN AND FINGER-OPERATED ANIMAL PUPPET TOY WITH INTEGRATED STIMULANTS” filed on Feb. 21, 2024.

### TECHNICAL FIELD

The present invention generally relates to hand-manipulative puppets, and more particularly to a hand-worn and finger-operated animal toy embodying stimulant for stimulating animals such as cats, or other similar animals.

### BACKGROUND

There are many different kinds of puppets designed to produce entertaining movements based on the manipulative efforts of the operator using his/her hand. Typically, puppets that simulate animals are already known, including those that specifically simulate an animal with a head and neck and contemplate animation movements of the head and neck caused by corresponding movements of the operator's hand and forearm.

Puppet types that are worn over the hand to permit direct finger manipulation do exist in the art such as one described in U.S. Pat. No. 3,942,283. The hand puppet of U.S. Pat. No. 3,942,283 resembles a stuffed animal and comprises a pocket extending therein into which the hand of a manipulator is inserted. The pocket is configured to extend into the legs and head of the animal so that the legs and head may be moved by the fingers of the manipulator.

Furthermore, U.S. Pat. No. 5,447,461 discloses a sound-generating hand puppet. The hand puppet includes a puppet glove to be worn by an operator's hand, a mouth-manipulating device secured in a head portion of the puppet glove having a mandible plate embedded in a lower-jaw sheath of a mouth portion of the puppet glove, and a maxilla plate embedded in an upper-jaw sheath of the mouth portion of the puppet glove, and a sound generator mounted in the mouth-manipulating device, whereby upon pivoting of the maxilla plate about the mandible plate to open the upper-jaw sheath to actuate the sound generator, a sound may be produced from the sound generator for imitating an animal or man's cry or singing for increasing a player's interest.

Most of the conventional hand puppets, in their simplest form, require only a head-like flexible shell mounted atop a tubelike costume. It is drawn over the hand, like a glove.

Although hand-manipulative animal puppets exist in the art, not all of require the involvement of all five fingers of an operator to selectively manipulate the mouth and limbs/arms of the animal. Further, the existing hand puppets fail to stimulate a real animal. The prior art hand puppet toys have been constructed with the concept in mind of combining, in one configuration, the attributes of a stuffed animal and a hand glove, but do not integrate any kind of features that would provide a more realistic feel of playing with an animal.

In the light of the foregoing, there is a need for a relatively easy-to-use, and more realistic hand-manipulative interactive puppet toy that's hand-worn and finger-operated so that the operator can selectively utilize his/her five fingers to manipulate the animal's mouth, and limbs. Additionally, the proposed interactive hand puppet embodies stimulants to stimulate real animals and increase their urge to play and interact with the hand puppet.

### SUMMARY

Accordingly, the present invention relates to a hand puppet useful for entertainment purposes, and more particularly to a hand-operated puppet having an animal body, and a sleeve portion. In use, the user's forearm or a portion of the forearm is laid into the sleeve whereas the palm portion, specifically the five fingers can reach into the animal body, wherein the middle finger is utilized to operate the head, forefinger/index finger and the ring finger is used to operate two upper arms, and thumb and little finger are utilized to operate the other two lower arms of the animal.

In an embodiment, the proposed hand puppet animal toy is configured to embody stimulants to stimulate real animals. The animal body portion of the hand puppet animal toy may comprise one or more pockets selectively configured on the arms/limbs for receiving the stimulants.

In another embodiment, the proposed hand puppet animal toy is configured to embody stimulants to stimulate real animals. The animal body portion of the hand puppet animal toy may comprise one or more bands (E.g. elastic or non-elastic band, for example, loincloth) selectively configured on the animal body portion of the hand puppet for receiving the stimulants. The band may include one or more pockets configured thereon at different positions for receiving the pouches holding the stimulants. The band may also be capable of holding the pouches containing the stimulants without any pockets.

According to an embodiment, the stimulants held in the pockets or bands replicate audible sounds (producing a crinkle sound) for opening or closing the puppet mouth, thereby enhancing the playing interest in the real animals and increasing engagement interest in real animals.

In the present invention, the hand puppet is configured for operation using 5-fingers and is capable of fitting most hand sizes, thereby making it a versatile product for kids, and adults of all ages.

In an embodiment, the animal body, and the sleeve portion of the hand puppet is made as a one-piece product. In another embodiment, the animal body, and a sleeve portion may be detachably attached to allow the users to clean them separately.

According to an aspect of the present invention, there is provided a hand-manipulated puppet of the type simulating an animal (Eg. a cat) having a head, and a body portion with four limbs extending therefrom. The hand-manipulated puppet includes a sleeve attached to the animal's body portion, one or more pockets selectively configured on one or more limbs, and/or the animal's body portion. The one or more pockets are configured to receive stimulant. A portion of the forearm of an operator is inserted into the sleeve, such that a palm portion with the five fingers of the operator reaches the animal's body portion and is selectively used to manipulate the animal's mouth, and the limbs. Out of five fingers, the middle finger is utilized to operate the head, forefinger/index finger, and the ring finger is used to operate two upper limbs, and thumb and little finger are utilized to operate the other two lower limbs of the animal.

According to the same aspect, the stimulant is packed in one or more pouches which are then selectively inserted into the one or more pockets located on the one or more limbs, and/or the front and the sides of the animal's body portion.

According to the same aspect, the protective sleeve may be made using multiple layers of fabric. For example, but not limited to 600D Oxford nylon that inhibits sharp points (from claws, teeth of animal 100) from piercing through. Additionally, in an embodiment, this multiple fabric layering continues to the palm side of the puppet 100, in the abdomen, chest, and arm regions. The rear side of the puppet 100 may be filled with PP cotton or equivalent material to make it thick enough to protect from scratching and biting actions of the puppet 100.

According to another aspect of the present invention, there is provided a hand-manipulated puppet of the type simulating an animal. The hand-manipulated puppet includes a head, a body portion with a plurality of limbs extending therefrom; and a sleeve attached to the animal's body portion. Further, the hand-manipulated puppet includes one or more pockets selectively configured on one or more limbs, and/or one or more bands covering the front abdomen and sides of the animal's body portion. The pockets are configured to receive stimulant. At least a portion of the forearm of an operator is inserted into the sleeve, such that a palm portion with the five fingers of the operator reaches the animal's body portion and is selectively used to manipulate the animal's mouth, and the limbs. Out of five fingers, the middle finger is utilized to operate the head, forefinger/index finger, and the ring finger is used to operate two upper limbs, and thumb and little finger are utilized to operate the other two lower limbs of the animal.

According to the same aspect, wherein the one or more bands covering the front abdomen and sides and back of the animal's body portion is at least a loincloth that can be wrapped around the animal's body, or a wearable attire.

According to the same aspect, the stimulant is packed in one or more pouches which are then selectively inserted into the one or more pockets located on the one or more limbs, and/or the one or more bands.

These and other features and advantages of the present invention will become apparent from the detailed description below, in light of the accompanying drawings.

### BRIEF DESCRIPTION OF THE DRAWINGS

In the drawings:

FIG. 1 shows a front perspective view of a hand-worn and finger-operated animal puppet toy with at least one pocket configured on a band covering the back portion and the genitals of the animal, according to a preferred embodiment of the present invention.

FIG. 2 shows a back view of the hand-worn and finger-operated animal puppet toy of FIG. 1.

FIGS. 3 and 4 show side views of the hand-worn and finger-operated animal puppet toy of FIG. 1, wherein in FIG. 3 a pocket located on one of the limbs is shown enlarged with a pouch holding the stimulants being inserted into the pocket.

FIG. 5 shows a front perspective view of a hand-worn and finger-operated animal puppet toy of FIG. 1 with at least one pocket configured on the sides of the band covering the back portion and the genitals of the animal

FIG. 6 shows a front perspective view of a hand-worn and finger-operated animal puppet toy configured in an operator's hand, according to another embodiment of the present invention.

FIG. 7 shows a cross-sectional back view of the animal puppet toy of FIG. 2 or FIG. 6, according to an embodiment of the present invention.

FIG. 8 shows another front perspective view of the animal puppet toy of FIG. 6.

FIG. 9 shows a front perspective view of the animal puppet toy of FIG. 8 with the sleeve portion having an adjustable strap, according to an alternative embodiment of the present invention.

FIG. 10 shows a front perspective view of the animal puppet toy of FIG. 8 in a two-piece configuration, according to another alternative embodiment of the present invention.

FIG. 11 shows a front perspective view of the animal body portion of the animal puppet toy alone with the inner liner cloth pulled out, according to an embodiment of the present invention.

FIG. 12 illustrates the front perspective view of the animal puppet toy of FIG. 8 with the selected limbs/arms enlarged to showcase pockets attached thereon and pouches of the stimulants being inserted into the pockets, according to an embodiment.

FIG. 13 illustrates a side perspective view of the animal puppet toy of FIG. 8 with the sleeve portion removed and wherein the selected body portion of the hand puppet is shown enlarged to showcase the pocket configured on a band surrounding the rear area and the front abdomen area of the animal body and wherein a pouch carrying the stimulant is shown being inserted into the pocket, according to yet another embodiment.

FIG. 14 illustrates the sleeve portion of the animal puppet toy of FIG. 8 with the pockets configured thereon for receiving pouches of the stimulant, according to one another embodiment.

FIG. 15 and 16 illustrate the front perspective view of the animal puppet toy of FIG. 8 with the selected limbs/arms shown enlarged to showcase the pockets with integrated pouches configured receiving loose stimulants, thereby eliminating the need for separate pouches of the stimulants as shown in FIG. 12 or FIG. 3, according to yet another possible embodiment.

FIG. 17 and 18 show a front perspective view of a hand-worn and finger-operated animal puppet toy having a thin and flexible sleeve portion to allow the operator to roll up the sleeve portion into the animal body portion, according to another alternative embodiment.

### DETAILED DESCRIPTION

Before describing the present invention in detail, it should be observed that the present invention utilizes a combination of components or processes, which constitutes hand-worn and finger-operated animal toy embodying stimulants for stimulating real animals and simulating animal-related attributes such as but not limited to sound. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

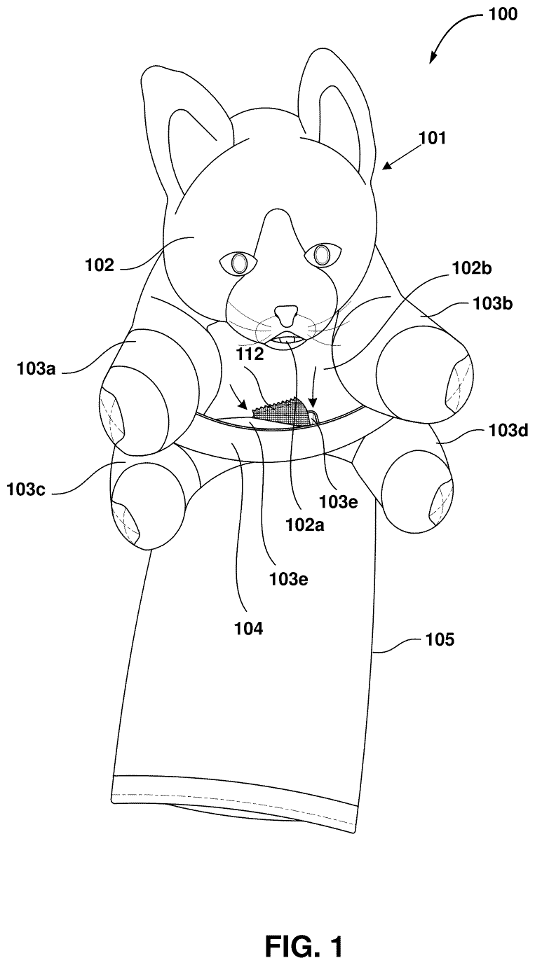

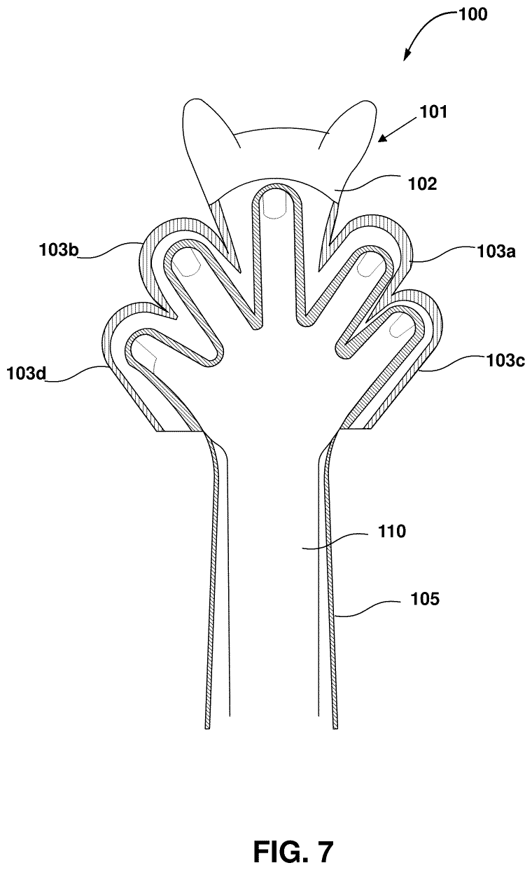

The hand-worn and finger-operated animal toy embodying stimulants for stimulating real animals and simulating animal attributes such as but not limited to sound, according to various embodiments of the present invention will now be described with reference to the accompanying drawings, particularly FIGS. 1-18.

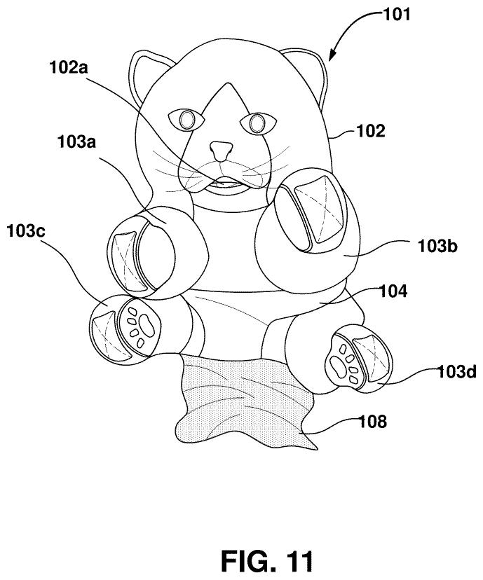

The accompanying figures show the hand puppet 100 of the present invention configured in various embodiments. According to a preferred embodiment shown in FIGS. 1-5, the hand-manipulated puppet 100 is of the type simulating a stuffed animal (E.g. a cat) 101. Although the accompanying figures showcase a cat as an animal, it should be understood that the animal may include any other 4-legged animal or mammal such as a tiger, or dinosaur. The animal 101 of the hand puppet 100 preferably includes a head 102 with a mouth 102a, and a body portion 102b with four limbs/arms 103a-103d extending from the body portion 102b. The stuffing inside the animal 101 may be present at specific portions of the animal body leaving an empty or open space inside the animal 101. The open space inside may be covered with an inner liner 108 (seen in FIG. 11) for receiving an operator's palm or wrist and five fingers. In an embodiment, the liner 108 may be removable to allow washing/cleaning of the liner 108.

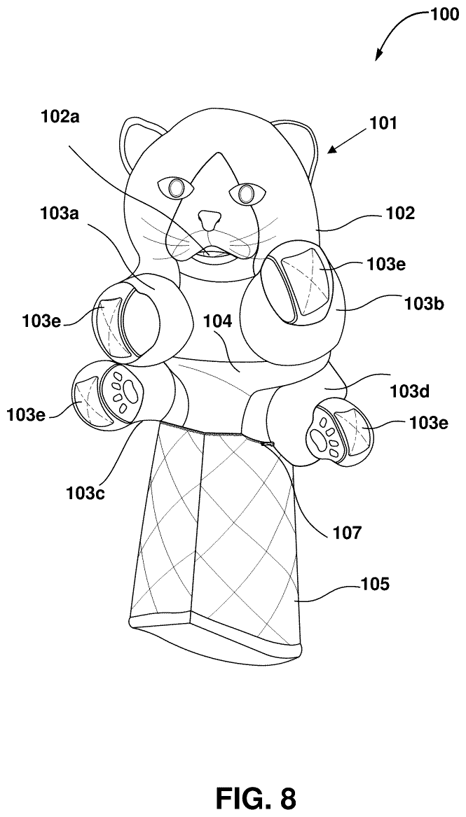

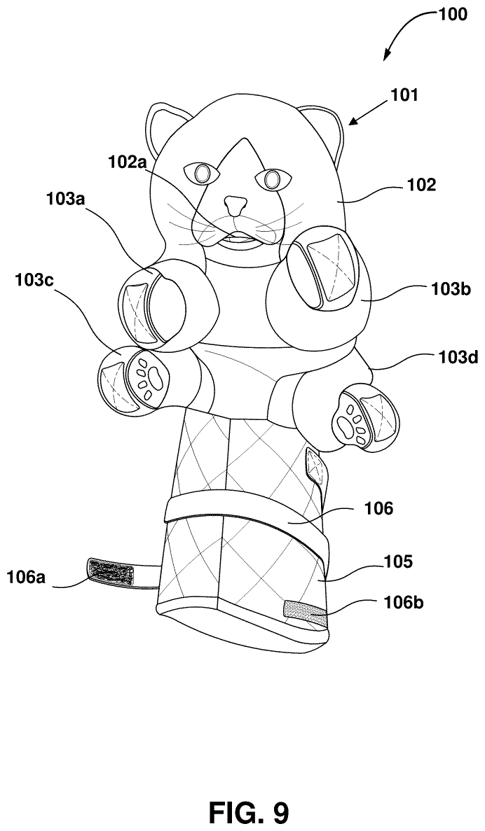

The hand-manipulated puppet 100 further comprises a protective sleeve 105. The sleeve 105 is attached to the animal's body portion 102b. In an embodiment as shown in FIGS. 1-5 or in FIGS. 8-9, the sleeve 105 may be permanently attached to the base of the animal 101. The attachment can be done by traditional sewing. The sleeve 105 also serves to protect the hand of the operator from the real animals being stimulated, while the operator is manipulating the hand puppet 100. The sleeve 105 may provide a larger area for the real animal to interact (play) with the puppet 100.

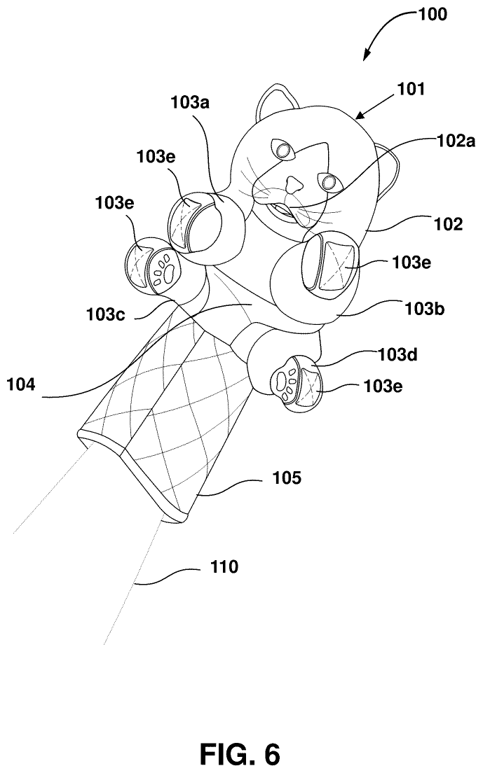

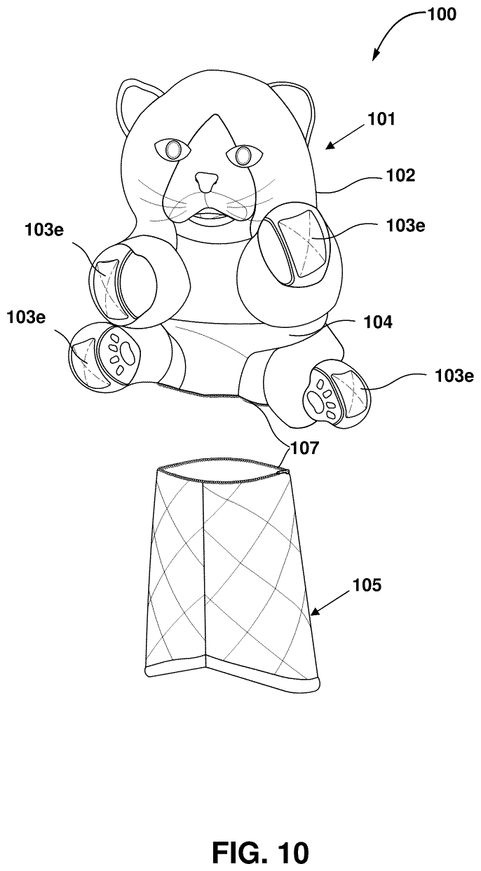

In another embodiment, as shown in FIG. 10, the sleeve 105 may be detachably attached to the base of the animal 101 using suitable attachment means, for example, zipper, Velcro, magnetic means, and so on. Although the accompanying FIG. 10 showcases the use of zipper means 107, it could be any other substitute attachment means that may detachably couple the sleeve 105 with the animal's body portion 102b. The sleeve 105 may comprise a variety of textures (material) for further stimulating the real animal as shown in another embodiment presented in FIG. 6, and FIGS. 8-10.

Referring to FIGS. 1 and FIG. 8, the sleeve 105 may be formed using a number of materials known in the art. The sleeve 105 is preferably made using durable and comfortable elastic or non-elastic material. The sleeve 105 may be made thicker embodying padding inside. The sleeve 105 may be made using anti-bite, anti-scratch, and breathable material. The sleeve 105 may be provided with soft linings all over the body as seen in FIGS. 8-10. In an embodiment, the protective sleeve 105 may be made using multiple layers of fabric. For example but not limited to 600D Oxford nylon that inhibits sharp points (from claws, teeth of animal 100) from piercing through. Any fabrics having high density, tightly weaved and durable may be used. Additionally, in an embodiment, this multiple fabric layering continues to the palm side of the puppet 100, in the abdomen, chest, and arm regions. The rear side of the puppet 100 may be filled with PP cotton or equivalent material to make it thick enough to protect from scratching and biting actions of the puppet 100.

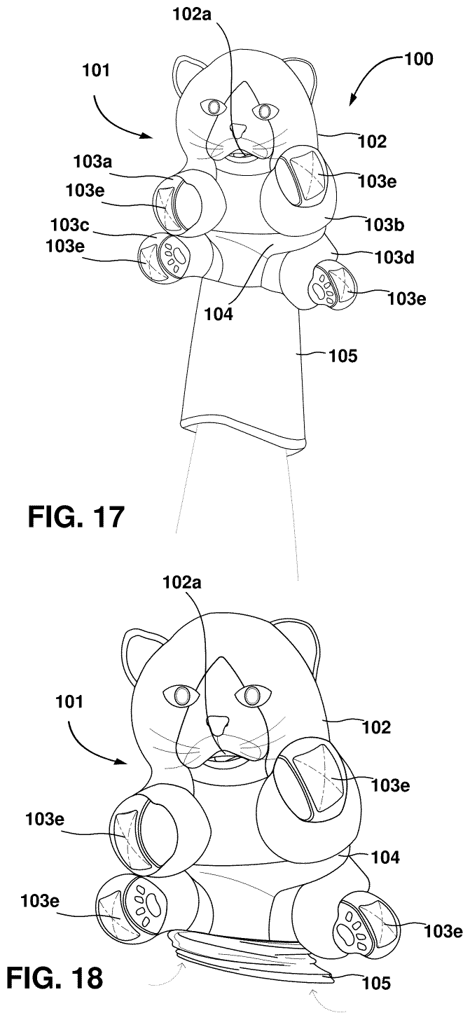

Additionally, according to another embodiment, as seen in FIGS. 17-18, the sleeve 105 may be made using one or more layers of soft and flexible material to allow the operator of the hand puppet 100 to roll up the sleeve 105 within the animal's body portion 102b. This may be useful for converting the hand puppet 100 to a normal stuffed toy for play purposes, when some children instead of performing interactive play with the hand puppet 100 want to use the hand puppet 100 as a normal stuffed animal toy.

Additionally, the sleeve 105 may be made using elastic material to provide a universal fit for differently sized arms, wrists, and hands. Furthermore, according to another embodiment, the sleeve 105 may be provided with an adjustable strap 106 (as seen in FIG. 9) that would facilitate adjusting sleeve 105 over different operator arm sizes or anatomy. The use of strap 106 is shown merely for the purpose of an exemplary embodiment, any other possible solutions may be implemented to replace the strap 106. In the provided adjustable strap 106, one end of the strap 106 is fixed on the sleeve 105 whereas the other free end (embodying the female Velcro portion 106a) gets coupled to a male Velcro portion 106b attached on the sleeve 105. The operator after putting his hand into the sleeve 105 of the puppet 100, can simply tighten the sleeve 105 around his hand using this strap 106 to adjust the sleeve 105 around his hand for better fit.

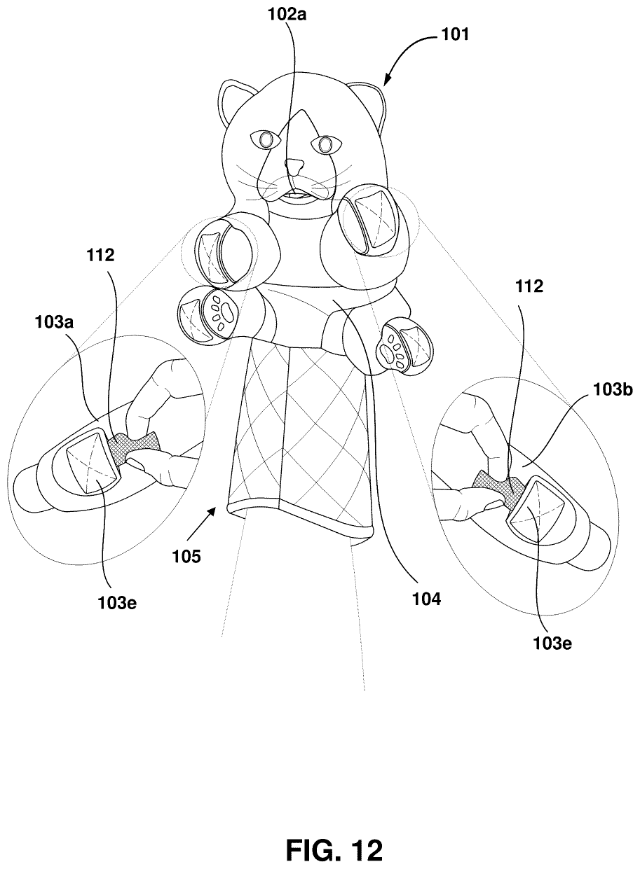

Referring to FIGS. 1,3,4-5 and FIGS. 12-13, 15-16, the hand-worn and finger-operated animal toy 100 of the present invention also embodies stimulant for simulating the real animals and simulating at least one animal-related attribute such as but not limited to crinkle sound. The stimulant may be in the form of herbs, powder, solid form, semi-solid form, and so on. For this application, the stimulant is preferably made available in the form of herbs that stimulate the real animals for playing or the stimulant may be in the form of material that may crinkle. However, it should be understood that the stimulant may be in any other form. As an essence of this invention, the integration of stimulant with the hand puppet 100 attracts real animal which otherwise appears missing in the prior art solutions. Further, an important aspect of the present invention is how the stimulants are integrally accommodated and at the same time concealed in the proposed hand puppet 100, which will be described in detail below.

The hand puppet 100 may include one or more pockets 103e selectively configured on at least the animal's body portion 102b including arms 103a-103d, and/or the sleeve 105 for receiving stimulants. In an embodiment, the pockets 103e may be formed on a band covering the back portion and the genitals of the animal 101.

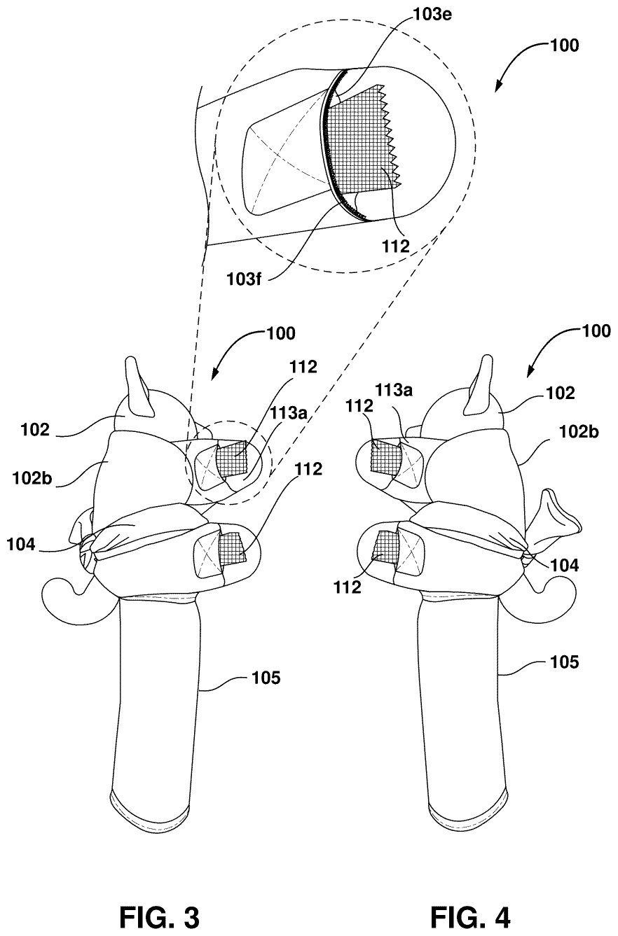

FIGS. 1, 3-5, and FIG. 12 illustrate the configuration of the pockets 103e on the animal 101 for receiving pouches 112 filled with stimulants. As seen, one or more pockets 103e may be selectively configured or located on selective limbs or all the limbs 103a-103d of the animal body 102b. Although the figures show the presence of the pockets 103e on the paws area of the limbs/arms 103a-103e of the animal 101, it should be understood that the pockets 103e may be present in any other areas of the limbs/arms 103a-103d. The pockets 103e may be configured on a first side 113a and/or a second side 113b of the limbs 103a-103d. Although FIGS. 3-4 shows the pockets 103e configured on the first side 113a, it should be understood that the pockets 103e may be configured on the opposite second side 113b. It is also possible to have the pockets 103e on both the sides 113a, 113b of the limbs 1031-103d. The pouches 112 filled with stimulants are removably insertable within these pockets 103e. Further, it is possible that each of the pocket's openings is left open or is made sealable using a zipper, Velcro, or any other suitable mechanisms known in the art. FIG. 3 shows the pockets 103e to include a zipper 103f to facilitate the closure or sealing of the pockets 103e so that the pouches carrying stimulant do not fall off during the wearing of the puppet 100 or playing with the real animal.

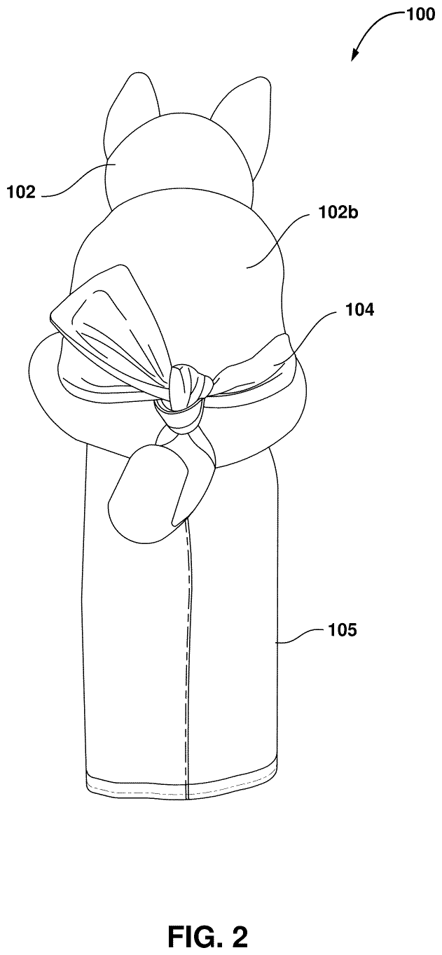

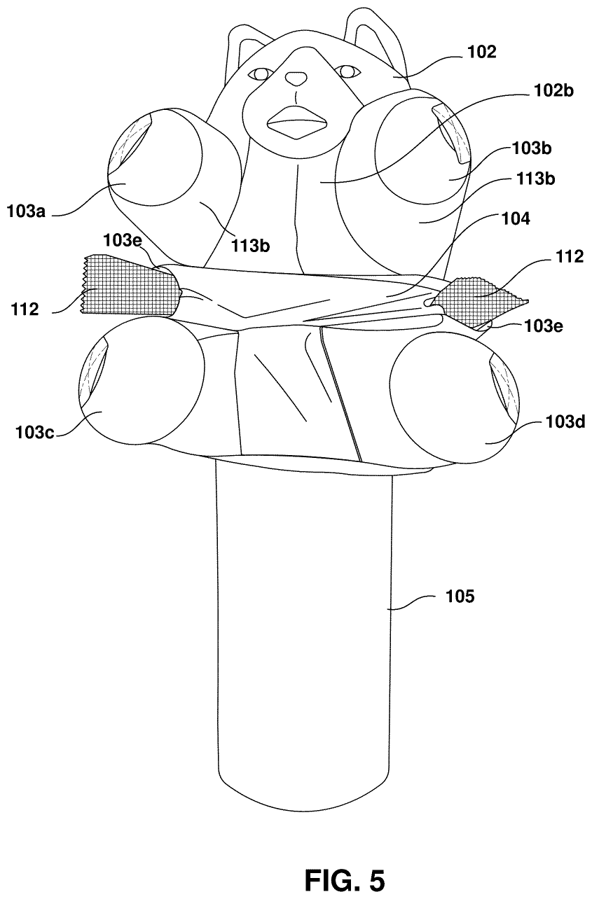

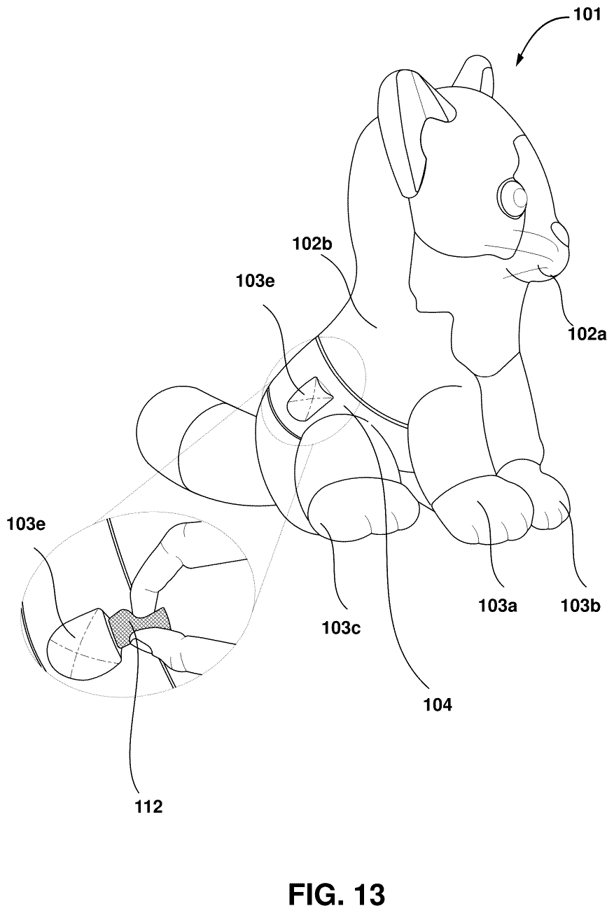

As a next possibility, the animal 101 is shown to be wearing a band 104 covering the back portion, and the genitals of the animal 101 as seen in FIG. 1 and 5, and in FIGS. 8-9,12. The band 104 itself may include one or more pockets 103e for accommodating the pouches 112 carrying the stimulants as best seen in FIG. 1 and 5. The pockets 103e may be selectively present on the stomach/abdomen area (FIG. 1) and/or on the right and left sides (FIG. 5 or FIG. 13). The pockets 103e may include or may not include closure means such as zipper, Velcro, etc. In another embodiment, as shown at least in FIG. 8, the band 104 may not include any pockets 103e rather the pouches 112 holding the stimulants may be inserted within the open band utilizing the elasticity of the band's material. One can pull away the band 104 in the area where the stimulant pouch 112 needs to be inserted and held using the band 104. The band 104 may be a loincloth. The band 104 may be elastic or non-elastic. In some other embodiment, instead of using loincloth that may be tied around the animal body (forming a knot at the back, as seen in FIG. 2), the band 104 may be configured as a wearable garment or harness or attire with pockets for accommodating the stimulants holding pouches 112, that can be out on and off of the animal body 102b. The pockets 103e are preferably open at one end and closed at the other end. The open end may be closeable using but not limited to Velcro, snap buttons, zippers.

In some other embodiments (not shown), instead of the formation of the pockets 103e on limbs 103a-103d and the wearable loincloth or garment, one or more bands may be selectively configured on limbs (or paws) 103a-103e that may act as two side open-ended pockets (not seen) for holding the pouches 112 holding the stimulants.

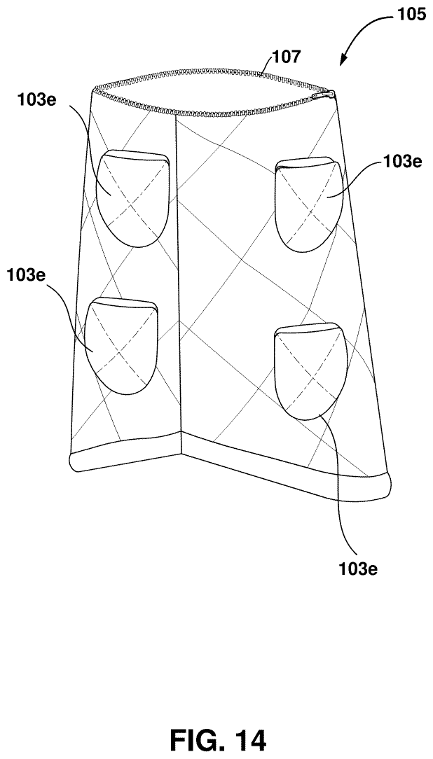

Further, according to some other embodiment, the one or more pockets 103e may be configured on the sleeve 105 as seen in FIG. 14.

According to an embodiment, the one or more pouches 112 containing the stimulants are made low profile, and porous with at least one open end for filling up stimulants there inside. According to the embodiments shown in FIGS. 1,3-5,12, the pouches 112 are first filled up with the stimulants (in the form of herbs for example), and the open end of the pouches 112 are closed (using the suitable closure mechanism for example button, zipper etc) and then the pouches 112 are selectively inserted into the pockets 103e. In this embodiment, the pouches 112 are externally present and replaceable with new pouches 112 holding the stimulants after the efficacy or effectiveness of preinstalled stimulants is reduced. The pouches 112 are formed in the size comparatively smaller than size of the pockets 103e where they are placed.

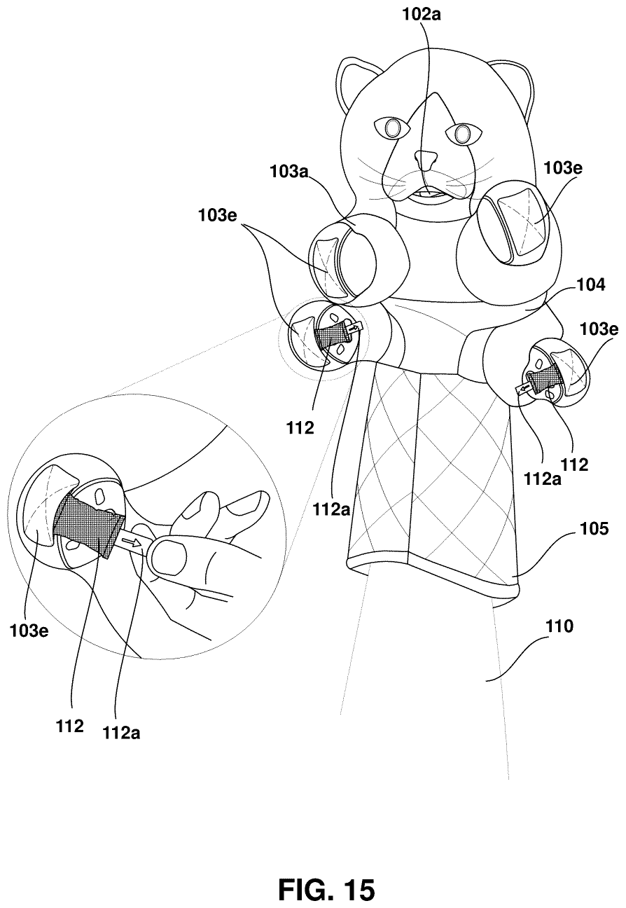

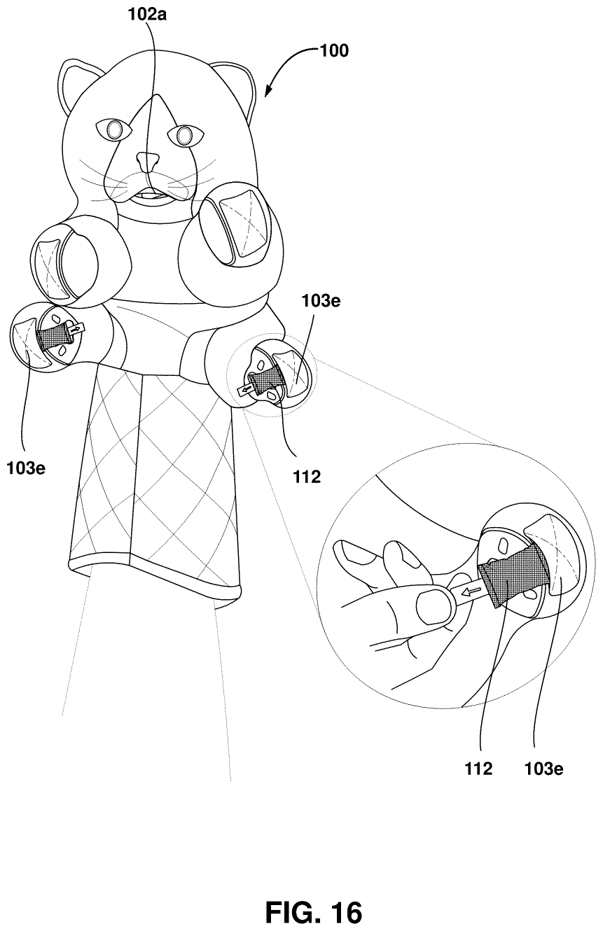

In another embodiment, as shown in FIGS. 15-16, the one or more pockets 103e may include a pouch 112 integrally attached there inside. Further, the pouch 112 may optionally comprise a pull tab 112a attached thereto to allow pulling out of the pouch 112 for refilling the stimulant within the pouch 112. This embodiment doesn't necessitate replacement of the pouches 112 providing an optimal solution (saving the cost towards the pouches) over the embodiment described and shown with respect to FIGS. 1,3-5,12. In this embodiment, the loose stimulants are refilled into the integrated pouches 112 formed within the pockets 103e.

In operation, as seen and can be understood from FIGS. 1 and 7 and FIGS. 6 and 7, when the operator inserts his hand/forearm into the sleeve 105 leading the palm or wrist inside the animal body 102b. Out of five fingers, the middle finger is utilized to operate the head 102, the forefinger/index finger, and the ring finger are used to operate two upper arms/limbs 103a-103b, and the thumb and little finger are utilized to operate the other two lower arms/limbs 103c-103d of the animal 101. The operator can selectively manipulate mouth 102a or any limbs/arms 103a-103d of the hand puppet 100 to present an interactive session. In other words, the operator, as the need be just work around the middle finger or any one of the fingers alone or simultaneously with any other fingers together based on needed actions that the operator might need to present using the puppet 100. Further, the presence of stimulants on various body areas including but not limited to the animal's paw or limbs or body attracts the real animal, thereby increasing the fun and enjoyment.

The embodiments described above describe the hand puppet 100 having an animal 101 and a sleeve 105, with the sleeve 105 attached (fixedly or removably) to the animal's body portion 102b. Further the presented embodiments describe how the stimulants carried in pouches are attached to the animal body 102b. However, it should be understood that the use of sleeve 105 is optional to the working of the invention. In other words, the animal 101 itself may also be worn on the operator's wrist or forearm (partially) without the sleeve 105 so that the operator's fingers can selectively manipulate the mouth 102a, and the arms 103a-103d of the animal 101.

Although particular embodiments of the invention have been described in detail for purposes of illustration, various modifications and enhancements may be made without departing from the spirit and scope of the invention.

What is claimed is:

1. A hand-manipulated puppet (100) of the type simulating an animal (101) having a head (102), and a body portion (102b) with four limbs (103a-103d) extending therefrom, the hand-manipulated puppet (100) comprising:
a sleeve (105) attached to the animal's body portion (102b);
one or more pockets (103e) selectively configured on one or more limbs (103a-103d), and/or the animal's body portion (102b), wherein the one or more pockets (103e) are configured to receive stimulant; and,
wherein at least a portion of the forearm of an operator is inserted into the sleeve (105), such that a palm portion with the five fingers of the operator reaches the animal's body portion (102b) and is selectively used to manipulate the animal's mouth (102a), and the limbs (103a-103d).

2. The hand-manipulated puppet (100) of claim 1, wherein the sleeve (105) is fixedly or detachably attached to the animal's body portion (102b).

3. The hand-manipulated puppet (100) of claim 1, wherein the sleeve (105) is made using anti-bite and anti-scratch, breathable elastic or non-elastic material.

4. The hand-manipulated puppet (100) of claim 1, wherein the sleeve (105) is provided with an adjustable strap that facilitates adjusting the sleeve (105) onto the different-sized arms.

5. The hand-manipulated puppet (100) of claim 1 further comprising one or more bands (104), or an attire having the one or more pockets (103e) that covers the back portion and genitals of the animal (101).

6. The hand-manipulated puppet (100) of claim 5, wherein the one or more bands (104) is a loincloth.

7. The hand-manipulated puppet (100) of claim 5, wherein the one or more pockets (103e) provided on the one or more bands (104) are further adapted to receive the stimulant.

8. The hand-manipulated puppet (100) of claim 7, wherein the one or more bands (104) or the attire comprises the one or more pockets (103e) located on an abdomen area in front and the one or more pockets (103e) located on sides of the animal's body portion (102b).

9. The hand-manipulated puppet (100) of claim 1, wherein the one or more pockets (103e) are selectively configured on a first side (113a) and/or a second side (113b) in proximity to the animal's paw on the limbs (103a-103d).

10. The hand-manipulated puppet (100) of claim 1, wherein out of five fingers, the middle finger is utilized to operate the head, forefinger/index finger, and the ring finger is used to operate two upper limbs (103a-103b), and thumb and little finger are utilized to operate the other two lower limbs (103c-103d) of the animal (101).

11. The hand-manipulated puppet (100) of claim 1, wherein the stimulant is packed in one or more pouches (112) which are then selectively inserted into the one or more pockets (103e) located on the one or more limbs (103a-103d), and/or the front and the sides of the animal's body portion (102b).

12. The hand-manipulated puppet (100) of claim 1, wherein the stimulant is refillable into one or more pouches (112) integrally attached within the one or more pockets (103e).

13. The hand-manipulated puppet (100) of claim 12, wherein the one or more pouches (112) comprises a pull tab (112) attached thereto to facilitate pulling out of the one or more pouches (112) for refilling with the stimulant.

14. The hand-manipulated puppet (100) of claim 1, wherein the stimulant is adapted to stimulate the real animals and simulate animal-related attribute including at least crinkle sound.

15. The hand-manipulated puppet (100) of claim 1, wherein the sleeve (105) is made using a plurality of fabric layers capable of preventing claws, and teeth of animal (100) from piercing through.

16. The hand-manipulated puppet (100) of claim 15, wherein the plurality of fabric layers continues to the palms of the limbs (103a-103d), abdomen, and chest from the sleeve (105).

17. A hand-manipulated puppet (100) of the type simulating an animal (101), comprising:
a head (102);
a body portion (102b) with a plurality of limbs (103a-103d) extending therefrom;
a sleeve (105) attached to the animal's body portion (102b);
one or more pockets (103e) selectively configured on one or more limbs (103a-103d), and/or one or more bands (104) covering the front abdomen and sides of the animal's body portion (102b), wherein the one or more pockets (103e) are configured to receive stimulant; and,
wherein at least a portion of the forearm of an operator is inserted into the sleeve (105), such that a palm portion with the five fingers of the operator reaches the animal's body portion (102b) and is selectively used to manipulate the animal's mouth (102a), and the limbs (103a-103d).

18. The hand-manipulated puppet (100) of claim 17, wherein the one or more bands (104) covering the front abdomen and sides and back of the animal's body portion (102b) is at least a loincloth that can be wrapped around the animal's body (102b), or is a wearable attire.

19. The hand-manipulated puppet (100) of claim 17, wherein out of five fingers, the middle finger is utilized to operate the head, forefinger/index finger, and the ring finger is used to operate two upper limbs (103a-103b), and thumb and little finger are utilized to operate the other two lower limbs (103c-103d) of the animal (101).

20. The hand-manipulated puppet (100) of claim 17, wherein the stimulant is packed in one or more pouches (112) which are then selectively inserted into the one or more pockets (103e) located on the one or more limbs (103a-103d), and/or the one or more bands (104).
